(19) United States
(12) Patent Application Publication
(10) Pub. No.: US 2004/0064305 A1
(43) Pub. Date: Apr. 1, 2004

(54) System, method, and program product for question answering

(76) Inventor: Tetsuya Sakai, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/665,284

(22) Filed: Sep. 22, 2003

(30) Foreign Application Priority Data
Sep. 27, 2002 (JP) 2002-284328

(51) Int. Cl. G06F 17/27

(52) U.S. Cl. 704/9

(57) ABSTRACT

A question answering system in which a first knowledge database including a knowledge source of a first language, and a second knowledge database including a knowledge source of a second language are used to obtain an answer to a question inputted in the first language by a user. A first acquisition unit retrieves, from the first knowledge database, a first prospective answer of the first language to the question. A first translation unit translates the question into the second language. A second acquisition unit retrieves, from the second knowledge database, a second prospective answer of the second language to the question translated into the second language. A second translation unit translates the second prospective answer of the second language into the first language. A processing unit ranks the first prospective answer in conjunction with a translation result of the second prospective answer.

### CROSS-REFERENCE TO RELATED APPLICATIONS

This application is based upon and claims the benefit of priority from the prior Japanese Patent Application No. 2002-284328, filed Sep. 27, 2002, the entire contents of which are incorporated herein by reference.

### BACKGROUND OF THE INVENTION

1. Field of the Invention

The present invention relates to a system, method, and program product for question answering.

2. Description of the Related Art

A document retrieval technique, as represented by a search engine on the Internet, of retrieving and ranking documents that matches a user's retrieval request has broadly spread. However, the document retrieval technique can satisfy retrieval requests such as “to read newspaper articles concerning . . . ”, and “to see Web pates concerning . . . ”, but cannot answer questions such as “Who is the president of ◯X Corporation?”, “What is the height of Mt. Fuji?”, and “Is the whale going to become extinct?”. That is, the document retrieval technique only returns the document or a passage in the document, and the user has to find the answer from an output result of document retrieval by oneself.

As a system for outputting the answer to the inputted question, a question answering system is known. In the conventional system, when a question like “Who is the president of ◯X Corporation?” is provided, an answer indicating the president's name of ◯X Corporation is outputted instead of outputting the documents concerning ◯X Corporation such as a homepage of ◯X Corporation. When a question like “What is the height of Mt. Fuji?” is provided, the system answers “It is 3776 m” to the question.

Heretofore, as disclosed in Jpn. Pat. Appln. KOKAI Publication No. 11-219368, conventional question answering systems have been researched as one type of an expert system. In recent years, the system has newly attracted attention as developed forms of the research such as information retrieval and information extraction.

An existing monolingual, e.g. “Japanese”, question answering system accepts a Japanese question and utilizes a Japanese knowledge source to generate an answer to the question. The system can easily be realized to a certain degree, with a combined use of the existing information retrieval technique for retrieving a text including a specific word and information extraction technique for extracting a specific type of information such as a person name, place name, and numeric value. However, the monolingual question answering system has the following problems.

A first problem is that an amount of information necessary for preparing the answer to the question is not sufficient. This results in a drop in coverage and reliability of the answer. For example, the information necessary for answering a certain Japanese question is described in an English web page but is not described in a Japanese web page in some case. In this case, a Japanese monolingual question answering system in which English information cannot be utilized fails in preparing the answer. This is a matter of coverage. For example, to the question “Who is the president of ◯X Corporation?”, suppose that two prospective answers “The president of ◯X Corporation is Mr. A.”, and “The president of ◯X Corporation is Mr. B.” can be retrieved from the Japanese knowledge source. On the other hand, suppose that one prospective answer “The president of ◯X Corporation is Mr. A.” can be retrieved from the English knowledge source. In this case, in the Japanese monolingual question answering system in which only the Japanese knowledge source can be utilized, it cannot be judged which answer has a higher reliability, Mr. A or Mr. B. However, considering both the Japanese and English knowledge sources, it can be guessed that the answer Mr. A has a high reliability. It is to be noted that an information retrieval apparatus is distinct from the question answering system. In the apparatus, even when a description language of a retrieval object database is different from that of an input keyword, the output of retrieval result faithful to the input keyword can be obtained (e.g., see Wendy G. Lehnert: “The Process of Question Answering—A Computer Simulation of Cognition”, Lawrence Erlbaum Associates, Publishers, Hillsdate, N. J. 1978).

A second problem is that the quality of the information necessary for preparing the answer to the question is slanted. For example, to the question “Is the whale going to become extinct?”, with the use of only the web page written in the language of a nation where whale fishery is carried out as the knowledge source, it is possible to obtain an answer only indicating “The whale is not going to become extinct. A certain kind of whales is rather increasing.” Conversely, with the use of only the web page written in the language of a nation which prohibits or objects to the whale fishery as the knowledge source, an answer only indicating “The whale is going to become extinct because whales are caught in excessive numbers in whaling nations” is probably obtained. When the language of the knowledge source is limited in this manner, viewpoints which have to be originally diversified are limited.

A third problem is that richness of the knowledge source differs with each language. Since the richness of the knowledge source differs, with respect to a certain specific question, it is preferable to use the knowledge source of language A enriched with the answer to the question. With respect to another specific question, it is preferable to use the knowledge source of language B enriched with the answer to the question, not the language A. This case likely frequently occurs. For example, with respect to a question concerning Queen Elizabeth, the English web page may be a most substantial knowledge source. However, with respect to a question concerning sumo wrestling, the Japanese web page may be the most substantial knowledge source. In the monolingual question answering system which cannot handle such difference of the richness, the quality of the answer is considerably uneven depending on the question.

### BRIEF SUMMARY OF THE INVENTION

An object of the present invention is to provide a system, method, and program product for question answering in which multiple knowledge sources are utilized for obtaining an answer.

According to embodiments of the present invention, there is provided a question answering system in which a first knowledge database including a knowledge source of a first language, and a second knowledge database including a knowledge source of a second language are used to obtain an answer to a question inputted in the first language by a user. A first acquisition unit retrieves, from the first knowledge database, a first prospective answer of the first language to the question. A first translation unit translates the question into the second language. A second acquisition unit retrieves, from the second knowledge database, a second prospective answer of the second language to the question translated into the second language. A second translation unit translates the second prospective answer of the second language into the first language. A processing unit ranks the first prospective answer in conjunction with a translation result of the second prospective answer. Then, an output unit outputs any one answer according to a result of the ranking.

### BRIEF DESCRIPTION OF THE SEVERAL VIEWS OF THE DRAWING

FIG. 1 is a block diagram showing a schematic configuration of a question answering system according to embodiments of the present invention;

FIG. 2 is a flowchart showing one example of a procedure of an information extraction unit according to embodiments of the present invention;

FIG. 3 is a flowchart showing one example of the procedure of a retrieval unit according to embodiments of the present invention;

FIG. 4A is a flowchart showing one example of the procedure of a question by a translation unit according to embodiments of the present invention;

FIG. 4B is a flowchart showing one example of the procedure of a prospective answer by the translation unit according to embodiments of the present invention;

FIG. 5 is a flowchart showing one example of the procedure of an answer preparation unit according to embodiments of the present invention;

FIG. 6 is a diagram showing one example of an output method of the prospective answer obtained by the question answering system according to embodiments of the present invention; and

FIG. 7 is a diagram showing another example of the output method of the prospective answer obtained by the question answering system according to embodiments of the present invention.

### DETAILED DESCRIPTION OF THE INVENTION

Embodiments of the present invention will be described hereinafter with reference to the drawings.

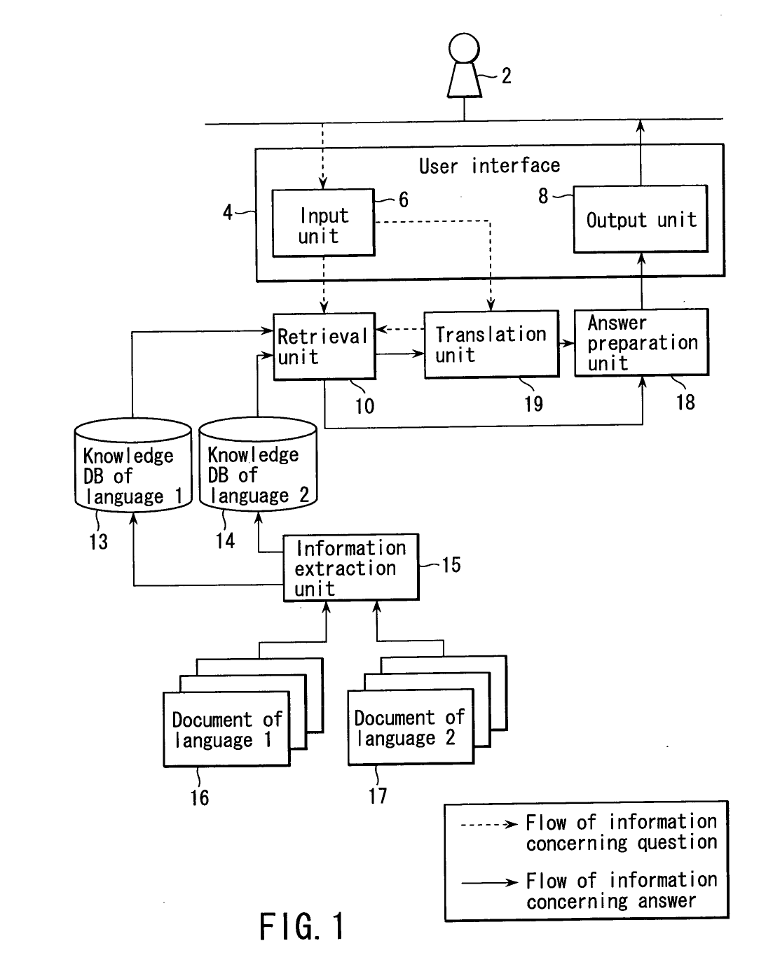

Referring now to FIG. 1, a configuration of a question answering system according to an embodiment of the present invention is schematically shown in a block diagram form. The question answering system may be realized using, for example, a general-purpose computer and software operating on the computer, and includes: a user interface 4 including an input unit 6 and output unit 8; a retrieval unit 10; an information extraction unit 15; an answer preparation unit 18; and a translation unit 19. In the user interface 4, hardware including input devices such as a keyboard and mouse, output devices such as a display, and the like is used. The retrieval unit 10, information extraction unit 15, answer preparation unit 18, and translation unit 19 may be realized as modules of a computer program which operates under a general-purpose operating system.

It is to be noted that an embodiment of the present invention may include a system which handles knowledge sources of an arbitrary number of languages. However, in the description of the embodiment, for the sake of convenience, it is assumed that the knowledge sources of two languages including Language 1 and Language 2 are handled. For example, it is assumed that Language 1 is “Japanese” and Language 2 is “English”.

First, a whole procedure of the present system will be described. Thereafter, a concrete procedure by a main module will be described in detail.

In FIG. 1, a dotted arrow shows a flow of information concerning a question, and a solid arrow shows a flow of information concerning an answer.

The information extraction unit 15 extracts the information from documents 16, 17 described in multiple languages beforehand, and prepares knowledge databases 13, 14 for each language.

When a user 2 inputs the question of Language 1 (Japanese herein) with respect to the input unit 6, the inputted question is transferred to the retrieval unit 10 and translation unit 19. The translation unit 19 translates the question into a question of Language 2 (English herein) and transfers the question to the retrieval unit 10.

The retrieval unit 10 retrieves an answer from the knowledge database (hereinafter referred to as “the Japanese knowledge database”) 13 of Language 1 (Japanese) with respect to the question transferred from the input unit 6. The retrieval unit 10 retrieves an answer from the knowledge database (hereinafter referred to as “the English knowledge database”) 14 of Language 2 (English) with respect to the question translated into English by the translation unit 19. A retrieval result (a prospective answer of Language 1) of the Japanese knowledge database 13 obtained thereby is transferred to the answer preparation unit 18, and a retrieval result (a prospective answer of Language 2) of the English knowledge database 14 is transferred to the translation unit 19. Next, the translation unit 19 translates the prospective answer of Language 2 into Language 1 and transfers the answer to the answer preparation unit 18. That is, the prospective answer described in English is translated into Japanese and transferred to the answer preparation unit 18.

As described above, the answer preparation unit 18 obtains the prospective answers unified in Language 1 (Japanese). Furthermore, the answer preparation unit 18 compares the prospective answers with one another, judges ranking of the answers, and transfers answer information to the output unit 8. In an embodiment, the output unit 8 determines a degree of freshness of each of the prospective answers. The output unit 8 then ranks the prospective answers according to the degree of freshness and outputs a result of the ranking.

In the above-described process, an important respect different from that of a conventional question answering system lies in that: the prospective answer in at least one language among the prospective answers in different languages, obtained as the retrieval result, is mechanically translated by the translation unit 19; the prospective answers are unified in the other language; and a prospective answer group unified in the language is subjected to a comparison process by the answer preparation unit 18.

There will be described hereinafter in detail with respect to each procedure of the information extraction unit 15, retrieval unit 10, translation unit 19, and answer preparation unit 18.

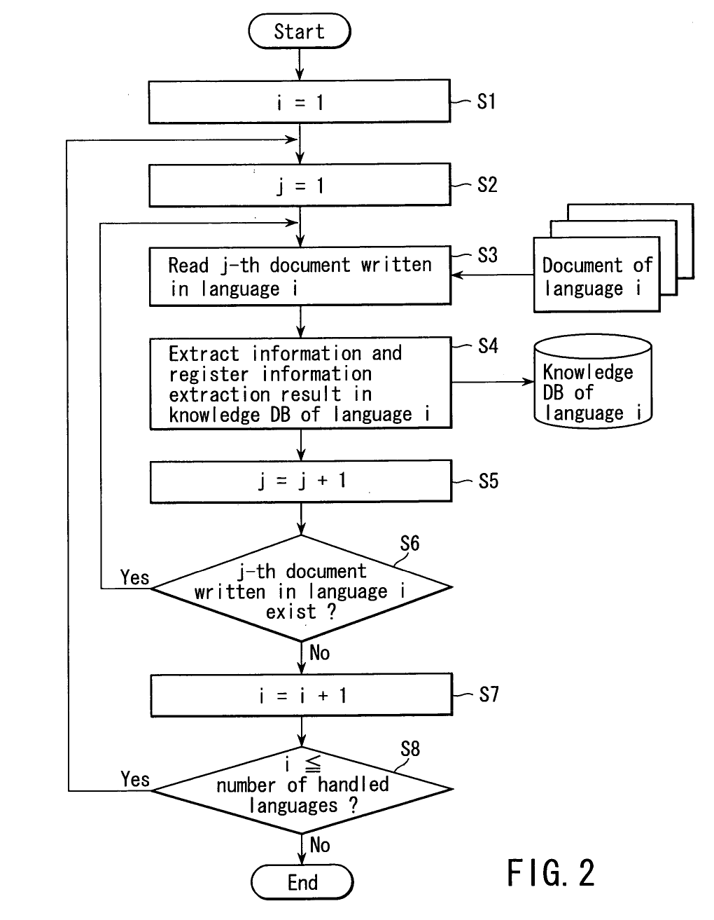

FIG. 2 is a flowchart showing one example of a procedure of the information extraction unit 15.

The information extraction unit 15 reads a j-th document (j=1, 2, . . . ) written in a language i (i=1, 2, . . . ), uses the existing information extraction technique to extract the information from the document, and registers the result in the knowledge database of the language i.

Here, examples of a concrete method of information extraction include a method by a morphological analysis and pattern matching. For example, when the knowledge source is Japanese, and when the document 16 includes a representation “◯X Corporation (president: ◯X Taro)”, this is morphologically analyzed to obtain an analysis result indicating “/◯X Corporation <proper noun>/ (<symbol>/ president <general noun>/:<symbol>/◯X Taro<proper noun>/) <symbol>”. It is to be noted that “/” denotes a break point of a part of speech.

Here, supposing the use of an information extraction rule for replacing arrangement of morphemes “/X<proper noun>/(<symbol>/president<general noun>/:<symbol>/Y<proper noun>/)<symbol>” with a knowledge representation “X[PRESIDENT=Y]”, knowledge “◯X Corporation[PRESIDENT==◯X Taro]” can be obtained.

Moreover, for example, with the use of the information extraction rule for replacing the arrangement of morphemes “/X<proper noun>/'s<particle>/Y<proper noun>/president<general noun>” with the knowledge representation “X[PRESIDENT==Y]”, the knowledge “◯X Corporation[PRESIDENT==◯X Taro]” can similarly be obtained from representation “◯X Corporation's ◯X Taro president. . . ”.

Furthermore, for example, when the knowledge source is English, part-of-speech tagging is performed instead of the morphological analysis. Accordingly, from representation “Taro ◯X, president of ◯X Corporation, . . . ” in the document 17, for example, the knowledge having a representation format “◯X Corporation[PRESIDENT==Taro_◯X” can be obtained.

It is to be noted that an identification number of an original document may also be added to the knowledge having the above-described representation format. In this manner, it is possible to grasp a document text from which each knowledge data has been obtained in a subsequent stage.

The information extraction unit 15 registers the knowledge obtained as described above for each language in the knowledge databases 13, 14.

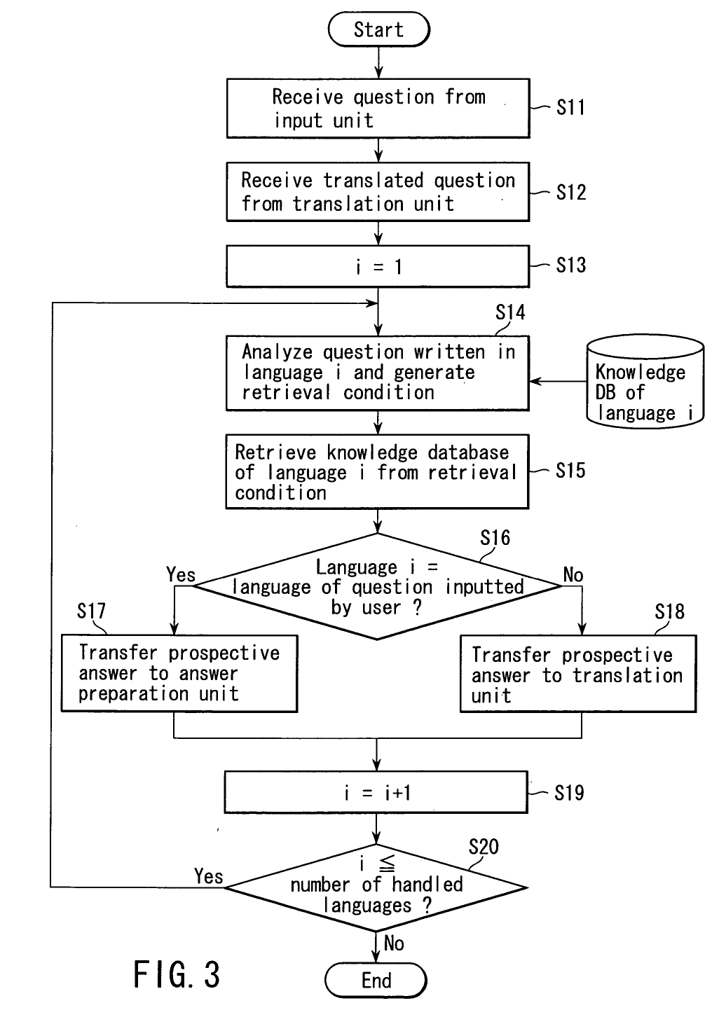

FIG. 3 is a flowchart showing one example of the procedure of the retrieval unit 10.

The retrieval unit 10 first receives a question from a user via the input unit 6 (step S11), and further receives the translation result of the question from the translation unit 19 (step S12). Moreover, with respect to each question written in the language i (i=1, 2, . . . ), a retrieval condition is generated. For example,. the retrieval unit 10 converts a Japanese question “Who is the president of ◯X Corporation?” to the retrieval condition in the representation format “◯X Corporation[PRESIDENT==*]” (step S13). Here, “*” indicates a wild card. The retrieval unit 10 uses the generated retrieval condition to retrieve an answer from the Japanese knowledge database 13 (step S15). Accordingly, for example, data such as “◯X Corporation[PRESIDENT==◯X Taro]” matches, and “◯X Taro” can be obtained as the prospective answer. It is to be noted that a plurality of prospective answers are obtained in general.

The retrieval unit 10 performs a similar process also with respect to the question other than Japanese. That is, for example, with respect to an English question “Who is the president of ◯X Corporation?”, this is converted to the retrieval condition “◯X Corporation[PRESIDENT==*]” (step S14). This is used to retrieve an answer from the English knowledge database 14 (step S15). Accordingly, “Taro_◯X” is obtained.

In step S16, the retrieval unit 10 judges whether or not the language of the question being processed is the same as that of the question inputted by the user, and transfers the prospective answer directly to the answer preparation unit 18 (step S17), or transfers the prospective answer to the translation unit 19 (step S18). For example, when the input language of the question by the user is Japanese, the prospective answer obtained by the retrieval of the Japanese knowledge database 13 is transferred as such to the answer preparation unit 18. The prospective answer obtained by the retrieval of the English knowledge database 14 is transferred to the translation unit 19 for the translation into Japanese.

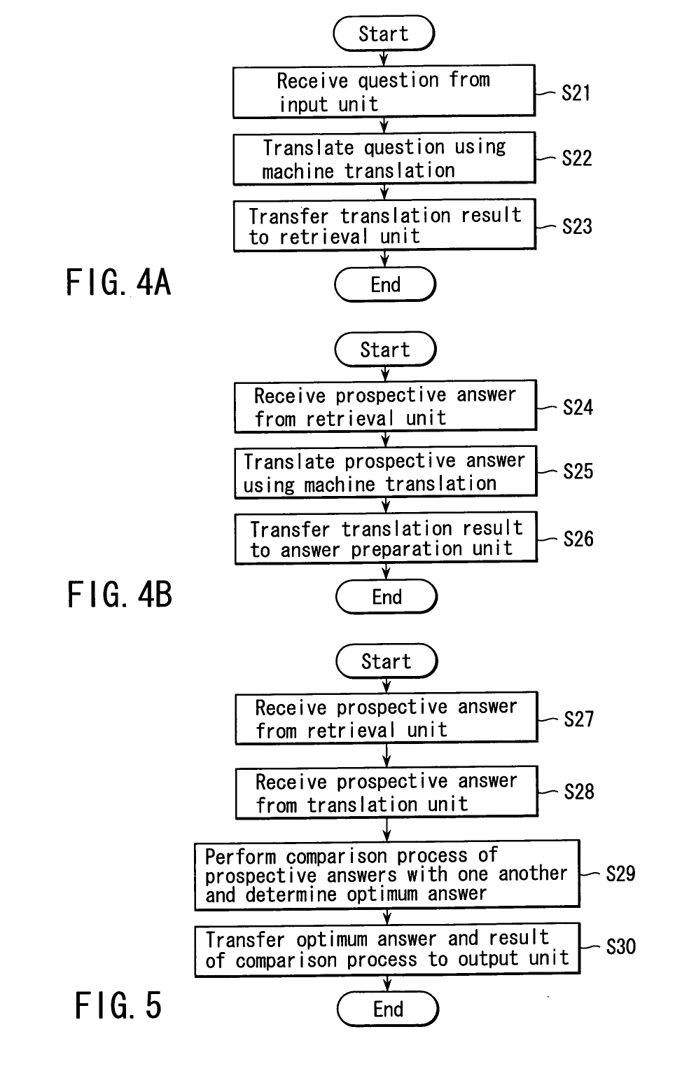

FIG. 4A is a flowchart showing one example of the procedure of the question by the translation unit 19, and FIG. 4B is a flowchart showing one example of the procedure of the prospective answer by the translation unit 19. The translation unit 19 mechanically translates the question to transfer the question to the retrieval unit 10. Alternatively, the prospective answer is mechanically translated and transferred to the answer preparation unit 18.

For example, upon receiving the question “Who is the president of ◯X Corporation?” from the input unit 6 (step S21), the translation unit 19 mechanically translates this into “Who is the president of ◯X Corporation?” (step S22), and transfers the result of the machine translation to the retrieval unit 10 (step S23). On the other hand, for example, on receiving a character train of the prospective answer such as “Taro_◯X” from the retrieval unit 10 (step S24), the translation unit 19 mechanically translates this into “◯X Taro” (step S25), and transfers the result of the machine translation to the answer preparation unit 18 (step S26).

FIG. 5 is a flowchart showing one example of the procedure of the answer preparation unit 18 according to the present embodiment.

The answer preparation unit 18 first receives the prospective answer from the retrieval unit 10 (step S27), and next receives the prospective answer also from the translation unit 19 (step S28). As described above, the language of the prospective answer received from the retrieval unit 10 is the same as that of the prospective answer received from the translation unit 19. For example, when the user asks a question in Japanese, the prospective answer received from the retrieval unit 10 is the Japanese prospective answer obtained by the retrieval of the Japanese knowledge database 13. On the other hand, the prospective answer received from the translation unit 19 is obtained by translating the English prospective answer obtained by retrieving the English knowledge database 14 by the retrieval unit 10 into Japanese. In this manner, the answer preparation unit 18 handles only the single language.

The answer preparation unit 18 performs a comparison process of these prospective answers with one another (step S29). Accordingly, the unit determines the ranking of the answers, and transfers an optimum answer or ranked answers to the output unit 8 (step S30). A ranking judgment method of the answers will be described hereinafter in detail.

Again it is considered that the Japanese question meaning “Who is the president of ◯X Corporation?” is inputted. As described, it is assumed that the information extraction rule is used for replacing the arrangement of morphemes “/X<proper noun>/'s<particle>/Y<proper noun>/president<general noun>” with the knowledge representation “X[PRESIDENT==Y]”. It is assumed that the Japanese document 16 used in preparing the Japanese knowledge database 13 includes the following representations:

(a) “◯X Taro president of ◯X Corporation”;

(b) “◯X president of ◯X Corporation”; and

(c) “◯X Corporation has decided investment into ΔΔ Corporation. The expectation of ◯X Corporation toward ΔΔ president is large.”

As the prospective answers, “◯X Taro”, “◯X”, “ΔΔ”, and the like are obtained. Here, the prospective answer “ΔΔ” is obtained, because the information extraction rule matches with the representation “(The expectation) of ◯X Corporation (toward) ΔΔ president (is large).” in the above (c). In actual, it is assumed that the answer is not adequate (It is to be noted that even with high precision of information extraction, it is also considered that non-truth is written in the original document. Therefore, in general, there is a little possibility that inappropriate answers are mixed in the prospective answers).

Here, it is assumed that as a result of retrieval of the Japanese knowledge database 13, three prospective answers “◯X Taro”, one prospective answer “◯X”, and one prospective answer “ΔΔ” are obtained. The Japanese question “Who is the president of the ◯X Corporation?” is translated into English, the English knowledge database 14 is retrieved based on the translation result of the question into English, and the prospective answer retrieved thereby is translated into Japanese. As a result, two prospective answers “◯X Taro”, and one prospective answer “◯X” are obtained. In the above-described case, the ranking of the answers can be determined in accordance with a simple majority decision method.

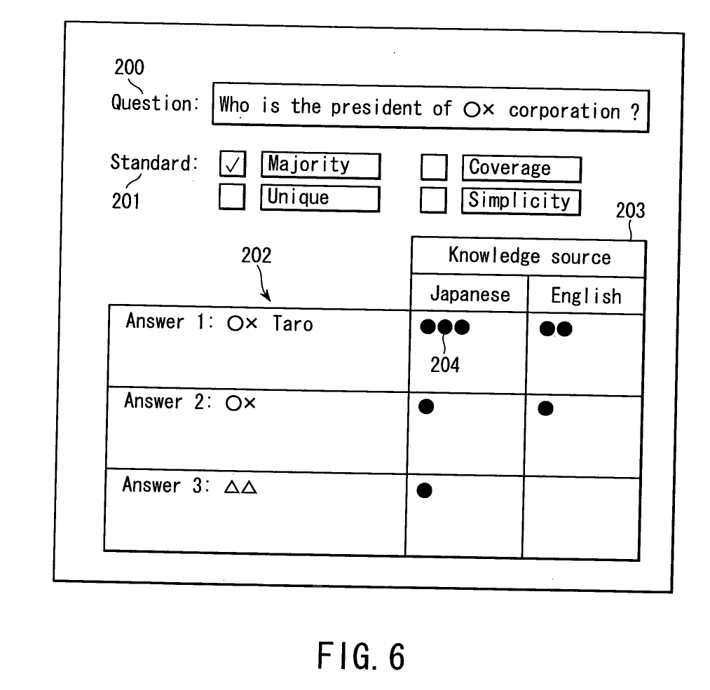

FIG. 6 is a diagram showing one example of an output method of the prospective answer obtained by the question answering system according to the present embodiment. Here, a plurality of (prospective) answers 1 to 3 (“◯X Taro”, “◯X”, “ΔΔ”) are sorted in order of hit in the retrieval into the Japanese knowledge database 13 and the retrieval into the English knowledge database 14 (202).

In the drawing, a mark 204 shown by a black circle “●” represents hit knowledge data. Since this mark 204 is sorted by knowledge source and shown in a table 203, the language type of the knowledge data can be judged by the user. It is to be noted that this mark indication is only one example. For example, instead of the mark 204, document ID may also be indicated. The mark 204 may be clickable, and the corresponding portion in the document of the knowledge source may be displayed in response to a user's click instruction.

In the display example of FIG. 6, the number of hits in the Japanese knowledge database 13 is one both for Answer 2 “◯X” and Answer 3 “ΔΔ”. In the question answering system using a conventional monolingual knowledge source, the answer to be employed cannot be judged. However, in an embodiment of the present invention, with respect to Answer 2 “◯X”, the answer is obtained from not only the Japanese knowledge source but also the English knowledge source. Therefore, it can be judged that the answer has a reliability higher than that of Answer 3 “ΔΔ” obtained only from the Japanese knowledge source.

Moreover, in the display example of FIG. 6, a check box 201 is disposed in such a manner that the user can select the output method of the prospective answer, and “majority” is selected here.

Contrary to the majority, the other alternatives of the output method include: “unique” for ranking and displaying the prospective answers on the basis of uniqueness (rareness) of the prospective answer; “coverage” for ranking and displaying the prospective answers on the basis of coverage (details) of the prospective answer; and “simplicity” for ranking and displaying the prospective answers on the basis of the simplicity of the prospective answer. Instead of sorting the answers simply on the basis of whether the number of hits is large or small, for example, the ranking may be performed so as to give priority to the prospective answer hit once in both the Japanese knowledge database 13 and English knowledge database 14 over the prospective answer hit twice in the Japanese knowledge database 13 (the total number of hits is two in both cases).

For example, it can easily be judged that the prospective answer “◯X” is a substring of “◯X Taro”. Then, “◯X Taro” having a larger information amount may preferentially be displayed.

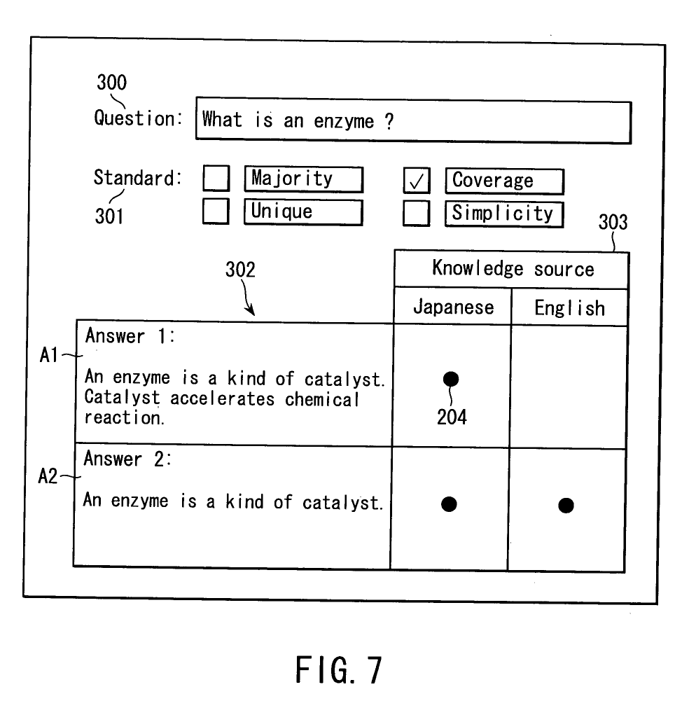

Another example in which the ranking of the prospective answers is determined from a viewpoint of coverage or simplicity is shown in FIG. 7. Here, the question is “What is an enzyme?”. This is a Japanese question requiring definition of a term as the answer (300). To handle this question 300, the information extraction unit 15 regards a text (e.g., a sentence or paragraph) including representation, for example, “. . . is a kind of . . . ” as a term definition, and extracts this representation beforehand. For example, with respect to the English knowledge source, a text including phrase representations such as “. . . is a kind of . . . ” and “. . . . is a type of . . . ” is regarded as the definition and extracted beforehand.

As in the example of FIG. 7, it is assumed that by the retrieval of the definition representations with respect to the Japanese knowledge database 13, for example, a text A1: “An enzyme is a kind of catalyst. The catalyst accelerates chemical reaction.” and a text A2: “An enzyme is a kind of catalyst” are obtained as the answers. Furthermore, when the Japanese question meaning “What is an enzyme?” is mechanically translated, the English question “What is an enzyme?” is obtained. It is further assumed that by the retrieval of the definition representations with respect to the English knowledge database 14, text “An enzyme is a kind of catalyst.” is obtained as the answer.

When the English answer is mechanically translated into Japanese, for example, A2′ “An enzyme is a kind of catalyst.” is obtained. Therefore, the answer preparation unit 18 receives the answers A1 and A2 from the retrieval unit 10, and A2′ from the translation unit 19.

In this case, the answer preparation unit 18 morphologically analyzes, for example, A1, A2, and A2′ to obtain “differences” of the terms. Based on this result, the unit can organize the prospective answers, and rank the priorities of the answers.

Concretely, from the answer A1, the differences of the terms such as “enzyme, catalyst, a kind, chemical, reaction, . . . ” are obtained. From A2 and A2′, the differences of the terms such as “enzyme, catalyst, a kind” are obtained. Accordingly, it is seen that the answers A2 and A2′ are equivalent to each other and that A1 has a coverage (detail) higher than that of A2 and A2′. This is presented to the user in a higher order of coverage of the answers as shown in FIG. 7.

Conversely, when the user demands “simplicity”, the answers may be displayed in an order reverse to that of FIG. 7.

It is to be noted that in the above description, the prospective answers are ranked, and the results sorted based on this are presented to the user. However, only one result having the maximum priority may be displayed.

According to the above described embodiments of the present invention, there is provided a question answering system in which multiple knowledge sources are utilized for obtaining an answer, so that coverage, reliability, variety, and stability of the answer are enhanced. Although, a technique referred to as cross-language information retrieval is known in which machine translation is used in document retrieval to realize the retrieval of English documents in response to a Japanese retrieval request, this technique merely calculates similarity between the retrieval request and the individual documents in order to rank the documents, and is different from embodiments of the present invention, in which the prospective answers are subjected to the machine translation and they are compared with one another to select an optimum answer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A question answering system in which a first knowledge database including a knowledge source of a first language, and a second knowledge database including a knowledge source of a second language are used to obtain an answer to a question inputted in the first language by a user, the system comprising:
a first acquisition unit configured to retrieve, from the first knowledge database, a first prospective answer of the first language to the question;
a first translation unit configured to translate the question into the second language;
a second acquisition unit configured to retrieve, from the second knowledge database, a second prospective answer of the second language to the question translated into the second language;
a second translation unit configured to translate the second prospective answer of the second language into the first language;
a processing unit configured to rank the first prospective answer in conjunction with a translation result of the second prospective answer; and
an output unit configured to output any one answer according to a result of ranking performed by the processing unit.

2. The system according to claim 1, wherein the processing unit ranks the first prospective answer in conjunction with the translation result of the second prospective answer according to whether the number of retrieval hits in the first knowledge database and the second knowledge database.

3. The system according to claim 1, further comprising:
an answer quality determination unit configured to determine simplicity or coverage of each of the first prospective answer and the second prospective answer based on lexical processing,
wherein the processing unit ranks the first prospective answer in conjunction with the translation result of the second prospective answer according to the simplicity or coverage determined by the answer quality determination unit.

4. The system according to claim 1, further comprising:
an answer freshness determination unit configured to determine a degree of freshness of each of the first prospective answer and the second prospective answer,
wherein the processing unit ranks the first prospective answer in conjunction with the translation result of the second prospective answer according to the degree of freshness determined by the answer freshness determination unit.

5. A question answering method for obtaining an answer to a question inputted in a first language by a user by use of a first knowledge database including a knowledge source of the first language, and a second knowledge database including a knowledge source of a second language, the method comprising:
retrieving, from the first knowledge database, a first prospective answer of the first language to the question;
translating the question into the second language;
retrieving, from the second knowledge database, a second prospective answer of the second language to the question translated into the second language;
translating the second prospective answer of the second language into the first language;
ranking the first prospective answer in conjunction with a translation result of the second prospective answer; and
outputting any one answer according to a result of the ranking.

6. The method according to claim 5, wherein the first prospective answer in conjunction with the translation result of the second prospective answer are ranked according to whether the number of retrieval hits in the first knowledge database and the second knowledge database.

7. The method according to claim 5, further comprising:
determining simplicity or coverage of each of the first prospective answer and the second prospective answer based on lexical processing,
wherein the first prospective answer in conjunction with the translation result of the second prospective answer are ranked according to the simplicity or coverage.

8. The method according to claim 5, further comprising:
determining a degree of freshness of each of the first prospective answer and the second prospective answer,
wherein the first prospective answer in conjunction with the translation result of the second prospective answer are ranked according to the degree of freshness.

9. A program product comprising a computer usable medium having computer readable program code means for. causing a computer to obtain an answer to a question inputted in a first language by a user by use of a first knowledge database including a knowledge source of the first language, and a second knowledge database including a knowledge source of a second language, the computer readable program code means in the computer program product comprising:
program code means for causing a computer to retrieve, from the first knowledge database, a first prospective answer of the first language to the question;
program code means for causing a computer to translate the question into the second language;
program code means for causing a computer to retrieve, from the second knowledge database, a second prospective answer of the second language to the question translated into the second language;
program code means for causing a computer to translate the second prospective answer of the second language into the first language;
program code means for causing a computer to rank the first prospective answer in conjunction with a translation result of the second prospective answer; and
program code means for causing a computer to output any one answer according to a result of the ranking.

10. The product according to claim 9, wherein the first prospective answer in conjunction with the translation result of the second prospective answer are ranked according to whether the number of retrieval hits in the first knowledge database and the second knowledge database.

11. The product according to claim 9, further comprising:
program code means for causing a computer to determine simplicity or coverage of each of the first prospective answer and the second prospective answer based on lexical processing,
wherein the first prospective answer in conjunction with the translation result of the second prospective answer are ranked according to the simplicity or coverage.

12. The product according to claim 9, further comprising:
program code means for causing a computer to determine a degree of freshness of each of the first prospective answer and the second prospective answer,
wherein the first prospective answer in conjunction with the translation result of the second prospective answer are ranked according to the degree of freshness.
